(19) United States
(12) Patent Application Publication
(10) Pub. No.: US 2012/0155748 A1
(43) Pub. Date: Jun. 21, 2012

(54) APPARATUS AND METHOD FOR PROCESSING STEREO IMAGE

(75) Inventor: Ho Chul Shin, Daejeon (KR)

(73) Assignee: ELECTRONICS AND TELECOMMUNICATIONS RESEARCH INSTITUTE, Daejeon (KR)

(21) Appl. No.: 13/327,751

(22) Filed: Dec. 15, 2011

(30) Foreign Application Priority Data
Dec. 16, 2010 (KR) 10-2010-0129529

(51) Int. Cl. G06K 9/00

(52) U.S. Cl. 382/154

(57) ABSTRACT

processing a stereo image by infrared images. Proposed are stereo image processing apparatus and method that may generate a correction pattern for stereo matching by analyzing in real time at least one of the stability of a stereo image, the number of feature points included in a camera image, and an illumination condition and emit the correction pattern toward a subject as a feedback value. According to exemplary embodiment of the present invention, it is possible to improve the stability and accuracy of the stereo image.

### CROSS-REFERENCE TO RELATED APPLICATIONS

This application claims priority to and the benefit of Korean Patent Application No. 10-2010-0129529 filed in the Korean Intellectual Property Office on Dec. 16, 2010, the entire contents of which are incorporated herein by reference.

### TECHNICAL FIELD

The present invention relates to an apparatus and a method for processing a stereo image, and more particularly, to an apparatus and a method for processing a stereo image by infrared images.

### BACKGROUND

A stereo image may provide useful information in an application using a camera image such as security and monitoring, object manipulation and recognition, a human computer interface (HCI), and the like. The stereo image may be obtained by calculating a subject distance of a camera image using parallax of a feature point of each image from a plurality of camera image inputs. In FIG. 1, three images positioned on the left are input camera images and three images positioned on the right are stereo images according to a related art. Referring to FIG. 1, it can be seen that the stereo image is expressed brighter as the stereo image becomes closer to an input image. However, when an illumination or the number of feature points included in an image is insufficient in processing the stereo image, the stability and accuracy of the stereo image is degraded as shown in FIG. 2. This is because the stereo image is susceptible to a neighboring illumination environment or background, whether a pattern of a subject exists, and the like.

### SUMMARY

The present invention has been made in an effort to provide an apparatus and a method for providing a stereo image that may generate a correction pattern for stereo matching by analyzing in real time at least one of the stability of a stereo image, the number of feature points included in a camera image, and an illumination condition and emit the correction pattern toward a subject as a feedback value.

An exemplary embodiment of the present invention provides an apparatus for processing a stereo image, including: an image processing unit to process images with respect to a subject; a stereo image generating unit to generate the stereo image by performing stereo matching of the processed images; an unstable area analyzing unit to analyze an unstable area in the generated stereo image in real time; and a correction pattern generating unit to generate a correction pattern to be reflected for stereo matching based on the analysis result.

The stereo image processing apparatus may further includes an illumination pattern generating unit to generate an illumination pattern using the generated correction pattern, and a subject emitting unit to emit the generated illumination pattern toward the subject as a feedback value.

The stereo image processing apparatus may further includes a feature point number determining unit to determine whether the number of first feature points included in a processed image is greater than or equal to the number of second feature points suitable for generating the stereo image, and a feature point insufficient area extracting unit to extract a feature point insufficient area with the insufficient number of feature points in the processed image in real time when the number of first feature points is less than the number of second feature points. The correction pattern generating unit further considers the extracted feature point insufficient area when generating the correction pattern.

The stereo image processing apparatus may further includes an illumination state analyzing unit to analyze an illumination state with respect to the subject in real time using a camera control value for controlling a camera that captures an image for the subject, and the processed images. The correction pattern generating unit further considers the illumination state when generating the correction pattern.

The unstable area analyzing unit may further includes an unstable area determining unit to determine whether there is a distorted area or an area in which a depth value difference between adjacent pixels is greater than or equal to a predetermined reference value, as an unstable area, in the generated stereo image, and an unstable area extracting unit to extract the unstable area in the generated stereo image when the unstable area exists in the generated stereo image.

The stereo image processing apparatus may further includes a stereo image application unit to apply the generated stereo image to at least one field of image monitoring, subject tracking, three-dimensional (3D) modeling of the subject, and an interaction between a human being and a robot.

The image processing unit may processes an infrared image as an image for the subject, and synchronizes the images for the subject and then processes the synchronized images using at least one image processing method of a brightness adjustment, a distortion correction, and a noise removal.

Another exemplary embodiment of the present invention provides a method of processing a stereo image, including: processing images with respect to a subject; generating the stereo image by performing stereo matching of the processed images; analyzing an unstable area in the generated stereo image in real time; and generating a correction pattern to be reflected for stereo matching based on the analysis result.

The stereo image processing method may further includes generating an illumination pattern using the generated correction pattern, and emitting the generated illumination pattern toward the subject as a feedback value.

The stereo image processing method may further includes determining whether the number of first feature points included in a processed image is greater than or equal to the number of second feature points suitable for generating the stereo image, and extracting a feature point insufficient area with the insufficient number of feature points, in the processed image in real time when the number of first feature points is less than the number of second feature points. The generating of the correction pattern further considers the extracted feature point insufficient area when generating the correction pattern.

The stereo image processing method may further includes analyzing an illumination state with respect to the subject in real time using a camera control value for controlling a camera that captures an image for the subject, and the processed images. The generating of the correction pattern further considers the illumination state when generating the correction pattern.

The analyzing of the unstable area may includes determining whether there is a distorted area or an area in which a depth value difference between adjacent pixels is greater than or equal to a predetermined reference value, as an unstable area in the generated stereo image, and extracting the unstable area in the generated stereo image when the unstable area exists in the generated stereo image.

The stereo image processing method may further includes applying the generated stereo image to at least one field of image monitoring, subject tracking, 3D modeling of the subject, and an interaction between a human being and a robot.

The processing of the images may processes an infrared image as an image for the subject, and synchronizes the images for the subject and then processes the synchronized images using at least one image processing method of a brightness adjustment, a distortion correction, and a noise removal.

According to exemplary embodiments of the present invention, it is possible to generate a correction pattern for stereo matching by analyzing in real time at least one of the stability of a stereo image, the number of feature points included in a camera image, and an illumination condition and emit the correction pattern toward a subject as a feedback value, thereby improving the stability and accuracy of the stereo image.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a view to compare a camera input image and a stereo image according to a related art.

FIG. 2 is a view illustrating a camera input image and a stereo image when an illumination or the number of feature points is insufficient according to a related art.

FIG. 3 is a block diagram schematically illustrating a stereo image processing apparatus according to an exemplary embodiment of the present invention.

FIG. 4 is the overall structural diagram of a stereo image processing apparatus using a feedback infrared pattern illumination.

FIG. 5 is an exemplary diagram of analyzing an unstable area in a stereo image.

FIG. 6 is an exemplary diagram of analyzing a location of a feature point.

FIG. 7 is an exemplary diagram showing an analysis result of an illumination condition.

FIG. 8 is an exemplary diagram showing a generation result of a correction pattern using stereo matching.

FIG. 9 is a diagram illustrating images before and after emitting a correction pattern.

FIG. 10 is a flowchart illustrating a method of processing a stereo image according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. Initially, when assigning reference numerals to constituent elements of drawings, like reference numerals refer to like elements throughout although they are illustrated in different drawings. In describing the present invention, when it is determined that detailed description related to a known function or configuration they may make the purpose of the present invention unnecessarily ambiguous, the detailed description will be omitted. Exemplary embodiments of the present invention will be described, however, the technical spirit of the present invention is not limited thereto or restricted thereby and may be modified by those skilled in the art and thereby be variously implemented.

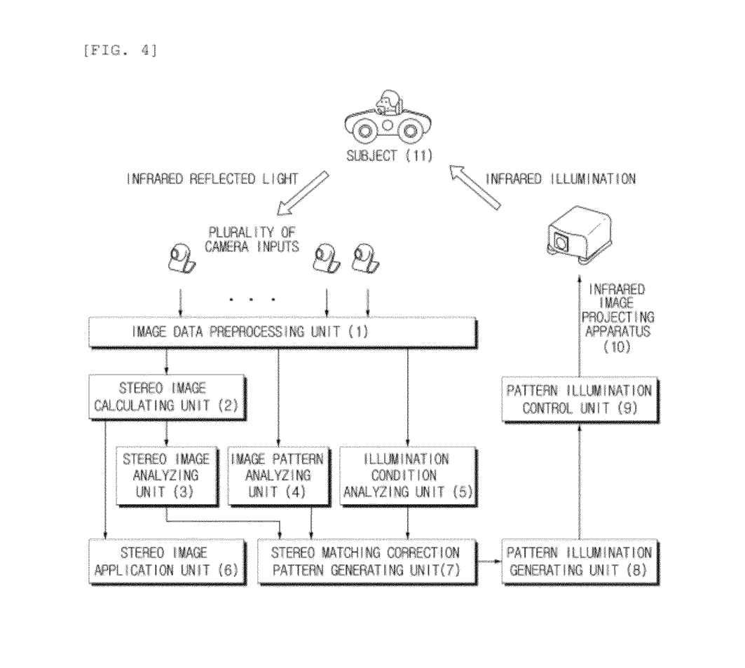

FIG. 3 is a block diagram schematically illustrating a stereo image processing apparatus 300 according to an exemplary embodiment of the present invention. Referring to FIG. 3, the stereo image processing apparatus 300 may include an image processing unit 310, a stereo image generating unit 311, an unstable area analyzing unit 312, a correction pattern generating unit 313, a power unit 320, and a main control unit 330.

The image processing unit 310 functions to process images with respect to a subject. The image processing unit 310 processes an infrared image as an image for the subject, and synchronizes the images for the subject and then processes the synchronized images using at least one image processing method of a brightness adjustment, a distortion correction, and a noise removal.

The stereo image generating unit 311 functions to generate the stereo image by performing stereo matching of the processed images.

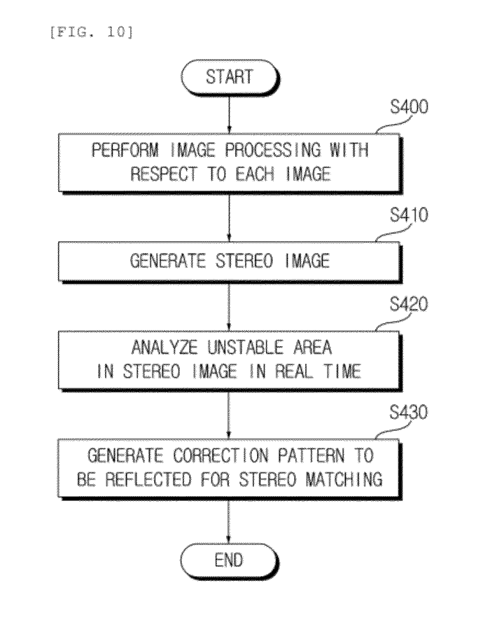

The unstable area analyzing unit 312 functions to analyze an unstable area in the generated stereo image in real time. When comparing (a) and (b) of FIG. 9, it can be known that much strip noise exists in an upper part of a body and a background. In the exemplary embodiment, the noise area is defined as the unstable area. Although not illustrated in FIG. 3, the unstable area analyzing unit 312 may include an unstable area determining unit and an unstable area extracting unit. The unstable area determining unit functions to determine whether there is a distorted area or an area in which a depth value difference between adjacent pixels is greater than or equal to a predetermined reference value, as an unstable area, in the generated stereo image. The unstable area extracting unit functions to extract the unstable area in the generated stereo image when the unstable area exists in the generated stereo image. In the exemplary embodiment, the area in which the depth value difference between the adjacent pixels is greater than or equal to the predetermined reference value indicates, for example, an area in which a boundary value is crushed.

The correction pattern generating unit 313 functions to generate a correction pattern to be reflected for stereo matching based on the analysis result.

The stereo image processing apparatus 300 may improve the stability and accuracy of the stereo image using a feedback signal. When considering this, the stereo image processing apparatus 300 may further include an illumination pattern generating unit 340 and a subject emitting unit 341. The illumination pattern generating unit 340 functions to generate an illumination pattern using the generated correction pattern. The subject emitting unit 341 functions to emit the generated illumination pattern toward the subject as a feedback value. The subject emitting unit 341 emits an infrared ray toward the subject.

The stereo image processing apparatus 300 may improve the stability and accuracy of the stereo image by generating the correction pattern through various types of analyses. When considering this, the stereo image processing apparatus 300 may further include a feature point number determining unit 350 and a feature point insufficient area extracting unit 351. The feature point number determining unit 350 functions to determine whether the number of first feature points included in a processed image is greater than or equal to the number of second feature points suitable for generating the stereo image. The feature point insufficient area extracting unit 351 functions to extract a feature point insufficient area with the insufficient number of feature points in the processed image in real time when the number of first feature points is less than the number of second feature points. When the stereo image processing apparatus 300 further includes the feature point number determining unit 350 and the feature point insufficient area extracting unit 351, the correction pattern generating unit 313 further considers the extracted feature point insufficient area when generating the correction pattern.

The stereo image processing apparatus 300 may further include an illumination state analyzing unit 360. The illumination state analyzing unit 360 functions to analyze an illumination state with respect to the subject in real time using a camera control value for controlling a camera that captures an image for the subject, and the processed images. When the stereo image processing apparatus 300 further includes the illumination state analyzing unit 360, the correction pattern generating unit 313 further considers the illumination state when generating the correction pattern. The illumination state analyzing unit 360 may use, for example, a camera primary view control value as the camera control value.

When considering various applications of the stereo image, the stereo image processing apparatus 300 may further include a stereo image application unit 370. The stereo image application unit 370 functions to apply the generated stereo image to at least one field of image monitoring, subject tracking, three-dimensional (3D) modeling of the subject, and an interaction between a human being and a robot. In the exemplary embodiment, in consideration of roles of the stereo image application unit 370, the stereo image processing apparatus 300 may be included in an image monitoring system, a subject tracking system, a 3D modeling system of the subject, a human computer interface (HCI) system, and the like.

The stereo image processing apparatus 300 is a stereo image processing apparatus using a feedback infrared pattern illumination. In the exemplary embodiment, stereo image processing indicates a method of calculating a distance difference between feature points within an image due to parallax of each camera using a plurality of camera inputs and calculating a 3D shape of the subject and a location of the subject. The stereo image can be widely used and has many advantages, however, has disadvantages in that the stereo image is susceptible to a neighboring illumination environment or background, whether a pattern of the subject exists, and the like. To overcome the above disadvantages, the exemplary embodiment proposes a method of generating a stereo matching correcting pattern capable of appropriately correcting the stereo image by analyzing the stability of the stereo image, the number of feature points included in a camera image, an illumination condition, and the like, and improving the stability and accuracy of the stereo image by emitting the infrared pattern illumination toward the subject based on the generated correction pattern.

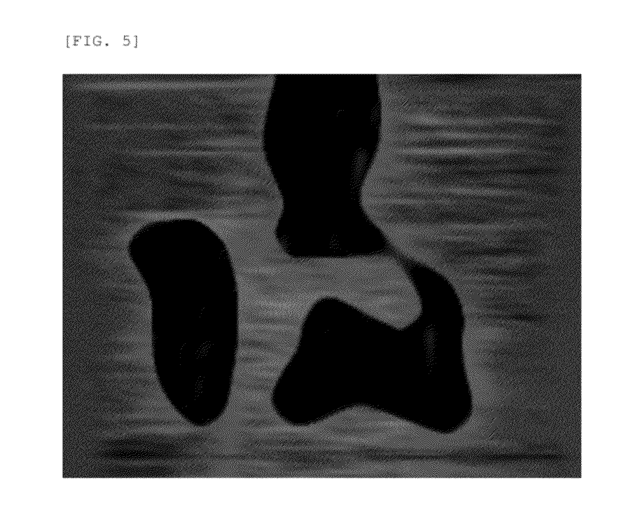

FIG. 4 is the overall structural diagram of a stereo image processing apparatus using a feedback infrared pattern illumination. The stereo image processing apparatus of FIG. 4 has the following features. First, when performing stereo image processing using a plurality of cameras, the stereo image processing apparatus improves the performance of stereo image processing using an infrared pattern illumination. Second, the stereo image processing apparatus improves the performance of stereo image processing by feeding back and analyzing image data and emitting the same using an infrared pattern illumination. Third, the stereo image processing apparatus emits, as a feedback value, an infrared pattern illumination that is obtained through a stereo image analyzing unit, an image pattern analyzing unit, an illumination condition analyzing unit, a stereo matching correction pattern generating unit, and the like. When the illumination condition or the number of features is insufficient through the above characteristics, the stereo image processing apparatus may complement the insufficient illumination condition or number of feature points using a feedback infrared pattern illumination, thereby improving the stability and accuracy of the stereo image.

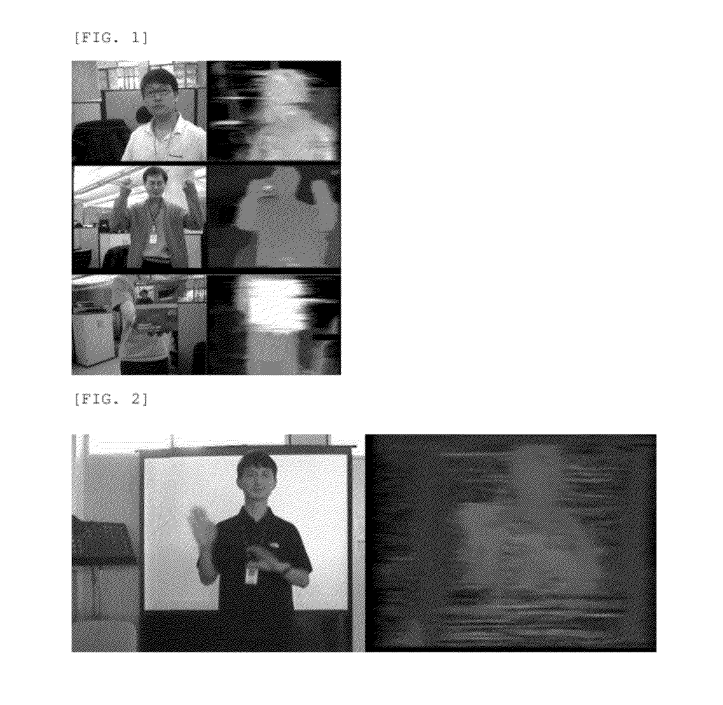

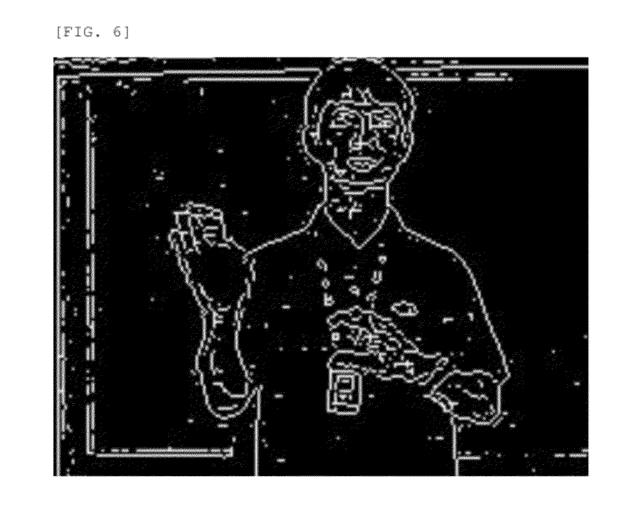

When infrared images are obtained from a plurality of cameras, an image data preprocessing unit 1 synchronizes the images and performs an image data preprocessing process of a brightness adjustment, a distortion correction, a noise removal, and the like. The image data preprocessing unit 1 corresponds to the image processing unit 310 of FIG. 3. Processed image data is stereo matched at a stereo image calculating unit 2 and thereby is converted to the stereo image positioned on the right of FIG. 1. The stereo image calculating unit 2 corresponds to the stereo image generating unit 311 of FIG. 3. A stereo image analyzing unit 3 analyzes an area in which the stability of an image is insufficient in the converted stereo image. The stereo image analyzing unit 3 corresponds to the unstable area analyzing unit 312 of FIG. 3. FIG. 5 is an exemplary diagram of analyzing an unstable area in a stereo image.

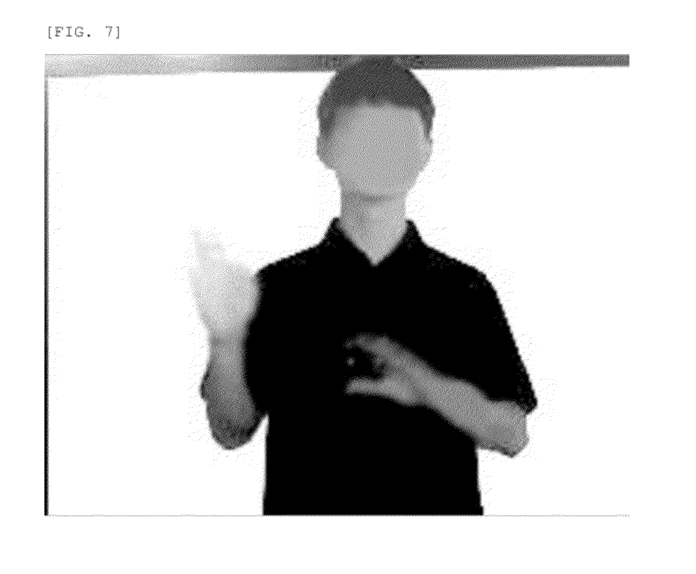

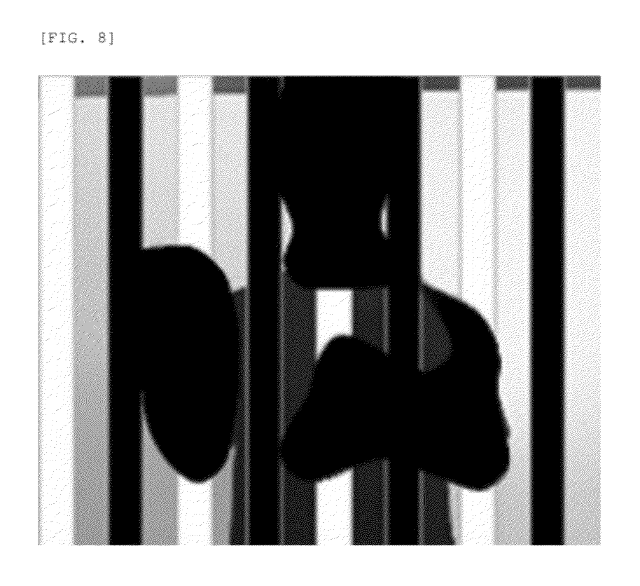

Data processed at the image data preprocessing unit 1 is used to analyze whether the number of feature points for stereo image calculation is insufficient and the insufficient area in a given image at an image pattern analyzing unit 4. The image pattern analyzing unit 4 corresponds to the feature point number determining unit 350 and the feature point insufficient area extracting unit 351 of FIG. 3. FIG. 6 is an exemplary diagram of analyzing a location of a feature point. An illumination condition analyzing unit 5 analyzes a camera control value and a result obtained from the image data processing unit 1 to thereby analyze a current illumination state of a subject 11. The illumination condition analyzing unit 5 corresponds to the illumination state analyzing unit 360 of FIG. 3. FIG. 7 is an exemplary diagram showing an analysis result of an illumination condition.

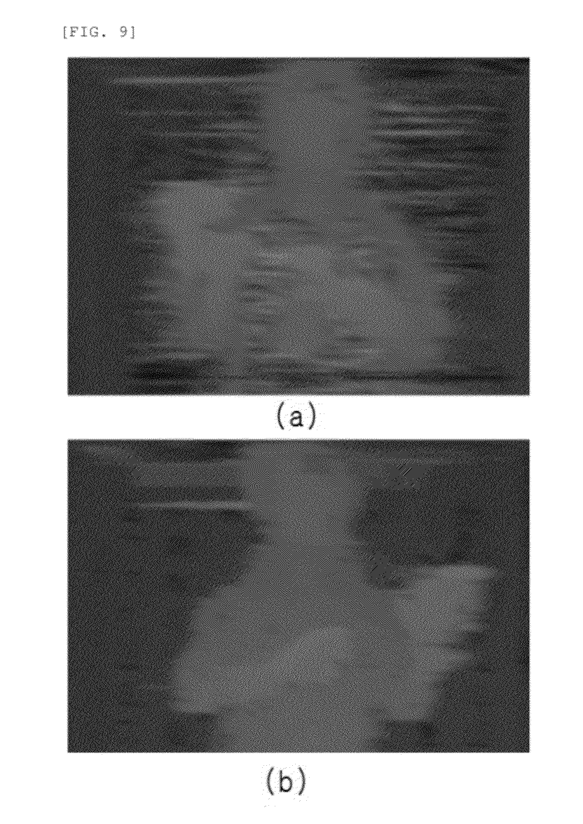

In the meantime, the calculated stereo image is transferred to a stereo image application unit 6 and is used for various types of stereo image applications. Data analyzed by the stereo image analyzing unit 3, the image pattern analyzing unit 4, and the illumination condition analyzing unit 5 is transferred to a stereo matching correction pattern generating unit 7 and is used to generate the correction pattern capable of optimizing the stability and accuracy of the stereo image. The stereo matching correction pattern generating unit 7 corresponds to the correction pattern generating unit 313 of FIG. 3. FIG. 8 is an exemplary diagram showing a generation result of a correction pattern using stereo matching.

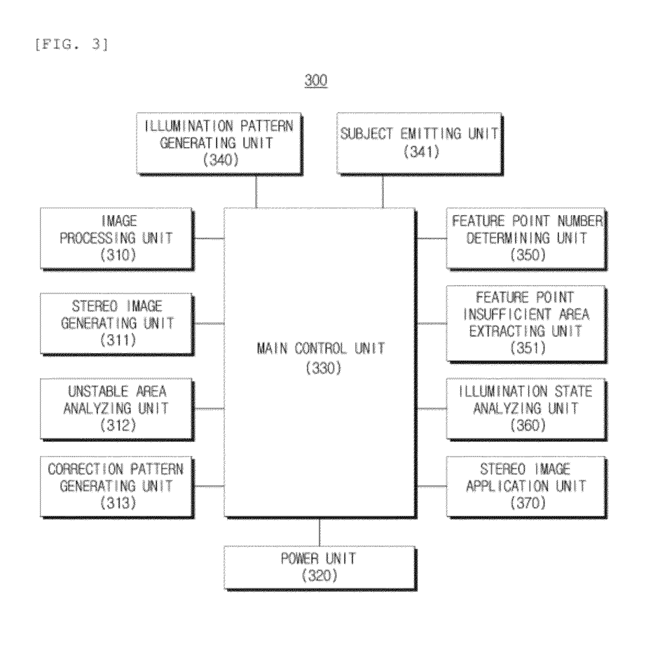

Due to characteristics of a stereo image, patterns such as horizontal stripes and the like appear in an unstable area of the stereo image as shown in FIG. 2. In FIG. 2, a face and arms appear relatively stable, however, noise in a characteristic form appears in clothes and a background. When analyzing the above noise pattern, it is possible to extract the unstable area of the stereo image. When the unstable area of the stereo image is detected as shown in FIG. 5, a circular image pattern as shown in FIG. 6 is analyzed with respect to the unstable area. When the illumination condition is analyzed as shown in FIG. 7, it is possible to verify whether an unstable cause of the stereo image is an insufficiency of the circular image pattern or an insufficiency of the illumination condition.

When the unstable area and the cause are calculated, an appropriate correction pattern is generated. When the insufficiency of the circular image pattern is a cause, a pattern is generated by emitting an artificial pattern such as vertical stripes and the like toward a portion in which the circular image pattern is insufficient. When the illumination condition is a cause, the brightness is adjusted to increase with respect to an area where the illumination is insufficient.

The generated correction pattern is transferred to a pattern illumination generating unit 8 and a pattern illumination control unit 9 and is used to emit the appropriate pattern illumination toward the subject 11 through an infrared image projecting apparatus 10. In FIG. 9, (a) is an image before emitting the correction pattern and (b) is an image after emitting the correction pattern. As shown in FIG. 9, when the correction pattern obtained according to the exemplary embodiment is emitted, the stability and accuracy of the stereo image is improved. The pattern illumination generating unit 8 corresponds to the illumination pattern generating unit 340 of FIG. 3 and the infrared image projecting apparatus 10 corresponds to the subject emitting unit 341 of FIG. 3.

Hereinafter, a stereo image processing method of a stereo image processing apparatus will be described. FIG. 10 is a flowchart illustrating a method of processing a stereo image according to an exemplary embodiment of the present invention. The following description refers to FIG. 10.

Initially, images with respect to a subject are processed (image processing operation S400). Desirably, image processing operation 5400 processes an infrared image as an image for the subject, and synchronizes the images for the subject and then processes the synchronized images using at least one image processing method of a brightness adjustment, a distortion correction, and a noise removal.

Next, the stereo image is generated by performing stereo matching of the processed images (stereo image generating operation S410).

Next, an unstable area is analyzed in the generated stereo image in real time (unstable area analyzing operation S420). In this instance, unstable area analyzing operation 5420 may include an unstable area determining operation and an unstable area extracting operation. The unstable area determining operation is an operation of determining whether there is a distorted area or an area in which a depth value difference between adjacent pixels is greater than or equal to a predetermined reference value, as an unstable area, in the generated stereo image. The unstable area extracting operation is an operation of extracting the unstable area in the generated stereo image when the unstable area exists in the generated stereo image.

Next, a correction pattern to be reflected for stereo matching is generated based on the analysis result (correction pattern generating operation S430).

In the exemplary embodiment, it is possible to improve the stability and accuracy of the stereo image using a feedback signal. When considering this, an illumination pattern generating operation and a subject emitting operation may be performed after correction pattern generating operation 5430. The illumination pattern generating operation is an operation of generating the illumination pattern using the generated correction pattern. The subject emitting operation is an operation of emitting the generated illumination pattern toward the subject as a feedback value.

In the exemplary embodiment, it is possible to improve the stability and accuracy of the stereo image by generating the correction pattern through various types of analyses. When considering this, a feature point number determining operation and a feature point insufficient area extracting operation may be performed simultaneously with unstable area analyzing operation 5420. The feature point number determining operation is an operation of determining whether the number of first feature points included in a processed image is greater than or equal to the number of second feature points suitable for generating the stereo image. The feature point insufficient area extracting operation is an operation of extracting a feature point insufficient area with the insufficient number of feature points in the processed image in real time when the number of first feature points is less than the number of second feature points. When the feature point number determining operation and the feature point insufficient area extracting operation is performed simultaneously unstable area analyzing operation 5420, correction pattern generating operation 5430 further considers an area in which the number of feature points extracted is insufficient when generating the correction pattern. In the mean time, the feature point number determining operation and the feature point insufficient area extracting operation is not limited to being performed simultaneously with unstable area analyzing operation 5420. For example, the feature point number determining operation and the feature point insufficient area extracting operation may be performed between stereo image generating operation 5410 and unstable area analyzing operation 5420, or between unstable area analyzing operation 5420 and correction pattern generating operation 5430.

In addition to the feature point number determining operation, the feature point insufficient area extracting operation, and the like, an illumination state analyzing operation may be further performed. The illumination state analyzing operation is an operation of analyzing an illumination state with respect to the subject in real time using a camera control value for controlling a camera that captures an image of the subject, and the processed images. When the illumination state analyzing operation is further performed in addition to the feature point number determining operation, the feature point insufficient area extracting operation, and the like, correction pattern generating operation 5430 further considers the illumination state when generating the correction pattern. In the meantime, the illumination state analyzing state is not limited to being performed simultaneously with unstable area analyzing operation 5420. For example, the illumination state analyzing operation may be performed between stereo image generating operation 5410 and unstable area analyzing operation 5420, or between unstable area analyzing operation 5420 and correction pattern generating operation 5430.

When considering various applications of the stereo image, the stereo image application operation may be performed after stereo image generating operation 5410. The stereo image application operation is an operation of applying the generated stereo image to at least one field of image monitoring, subject tracking, 3D modeling of the subject, and an interaction between a human being and a robot. The stereo image application operation may be performed at any stage after the stereo image generating operation. For example, the stereo image application operation may be performed between the stereo image generating operation and the unstable area analyzing operation.

The present invention may be applied to an image processing technology field. In particular, the present invention may be applied to a security monitoring technology field using a stereo image, a technology field of recognizing and tracking an object, an HCI technology field, a 3D modeling technology field, a robot vision technology field, and the like.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for processing a stereo image, comprising:
an image processing unit to process images with respect to a subject;
a stereo image generating unit to generate the stereo image by performing stereo matching of the processed images;
an unstable area analyzing unit to analyze an unstable area in the generated stereo image in real time; and
a correction pattern generating unit to generate a correction pattern to be reflected for stereo matching based on the analysis result.

2. The apparatus of claim 1, further comprising:
an illumination pattern generating unit to generate an illumination pattern using the generated correction pattern; and
a subject emitting unit to emit the generated illumination pattern toward the subject as a feedback value.

3. The apparatus of claim 1, further comprising:
a feature point number determining unit to determine whether the number of first feature points included in a processed image is greater than or equal to the number of second feature points suitable for generating the stereo image; and
a feature point insufficient area extracting unit to extract a feature point insufficient area with the insufficient number of feature points in the processed image in real time when the number of first feature points is less than the number of second feature points,
wherein the correction pattern generating unit further considers the extracted feature point insufficient area when generating the correction pattern.

4. The apparatus of claim 3, further comprising:
an illumination state analyzing unit to analyze an illumination state with respect to the subject in real time using a camera control value for controlling a camera that captures an image for the subject, and the processed images,
wherein the correction pattern generating unit further considers the illumination state when generating the correction pattern.

5. The apparatus of claim 1, wherein the unstable area analyzing unit comprises:
an unstable area determining unit to determine whether there is a distorted area or an area in which a depth value difference between adjacent pixels is greater than or equal to a predetermined reference value, as an unstable area, in the generated stereo image; and
an unstable area extracting unit to extract the unstable area in the generated stereo image when the unstable area exists in the generated stereo image.

6. The apparatus of claim 1, further comprising:
a stereo image application unit to apply the generated stereo image to at least one field of image monitoring, subject tracking, three-dimensional (3D) modeling of the subject, and an interaction between a human being and a robot.

7. The apparatus of claim 1, wherein the image processing unit processes an infrared image as an image for the subject, and synchronizes the images for the subject and then processes the synchronized images using at least one image processing method of a brightness adjustment, a distortion correction, and a noise removal.

8. A method of processing a stereo image, comprising:
processing images with respect to a subject;
generating the stereo image by performing stereo matching of the processed images;
analyzing an unstable area in the generated stereo image in real time; and
generating a correction pattern to be reflected for stereo matching based on the analysis result.

9. The method of claim 8, further comprising:
generating an illumination pattern using the generated correction pattern; and
emitting the generated illumination pattern toward the subject as a feedback value.

10. The method of claim 8, further comprising:
determining whether the number of first feature points included in a processed image is greater than or equal to the number of second feature points suitable for generating the stereo image; and
extracting a feature point insufficient area with the insufficient number of feature points, in the processed image in real time when the number of first feature points is less than the number of second feature points,
wherein the generating of the correction pattern further considers the extracted feature point insufficient area when generating the correction pattern.

11. The method of claim 10, further comprising:
analyzing an illumination state with respect to the subject in real time using a camera control value for controlling a camera that captures an image for the subject, and the processed images,
wherein the generating of the correction pattern further considers the illumination state when generating the correction pattern.

12. The method of claim 8, wherein the analyzing of the unstable area comprises:
determining whether there is a distorted area or an area in which a depth value difference between adjacent pixels is greater than or equal to a predetermined reference value, as an unstable area in the generated stereo image; and
extracting the unstable area in the generated stereo image when the unstable area exists in the generated stereo image.

13. The method of claim 8, further comprising:
applying the generated stereo image to at least one field of image monitoring, subject tracking, 3D modeling of the subject, and an interaction between a human being and a robot.

14. The method of claim 8, wherein the processing of the images processes an infrared image as an image for the subject, and synchronizes the images for the subject and then processes the synchronized images using at least one image processing method of a brightness adjustment, a distortion correction, and a noise removal.
